(19) United States
(12) Patent Application Publication
(10) Pub. No.: US 2008/0077590 A1
(43) Pub. Date: Mar. 27, 2008

(54) Efficient journaling and recovery mechanism for embedded flash file systems

(75) Inventor: Anil Kumar Pandit, Bangalore (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/525,637

(22) Filed: Sep. 22, 2006

(51) Int. Cl. G06F 17/30

(52) U.S. Cl. 707/8

(57) ABSTRACT

Implicit journaling of a file operation relating to a file stored in a flash memory is performed by locking a semaphore corresponding to the file on which a file operation is to be performed, by initializing journaling of the file operation using the file map, by performing the file operation on the file, by completing journaling of the file operation using a file map corresponding to the file, and unlocking the semaphore. Additionally or alternatively, a file system is placed in a stable state following an interruption occurring during a file operation by scanning File Maps corresponding to the files, determining whether a file operation is incomplete based on validity flags contained in the file maps, and performing remediation so as to eliminate the incomplete file operation.

### TECHNICAL FIELD

The technical field of the present application relates to journaling and recovery of file systems in persistent storage media such as flash memories.

### BACKGROUND

Flash memory (e.g., Electrically-Erasable Programmable Read-Only Memory or “EEPROM”) has been used as long-term memory in computers, printers, and other instruments. Flash memory reduces the need for separate magnetic disk drives, which can be bulky, expensive, and subject to breakdown.

A flash memory typically includes a large plurality of devices, such as floating-gate field effect transistors, arranged as memory cells, and also includes circuitry for accessing the cells and for placing the devices in memory conditions (such as 0 or 1). These devices retain information even when power is removed, and their memory conditions can be erased electrically while the flash memory is in place.

One disadvantage of flash memory in comparison to other memories such as hard disks is that flash memory must be erased before it can be reprogrammed, while old data on a hard disk can simply be over-written when new information is to be stored thereon. Thus, when a file which is stored in flash memory changes, the changes are not written over the old data but are rather written to one or more new free blocks of the flash memory, and the old data is marked unavailable, invalid, or deleted, such as by changing a bit in a file header or in another control unit stored on the flash memory.

Because flash memory cannot be reprogrammed until it has been erased, valid information that is to be preserved in the flash memory must be rewritten to some other memory area before the area of the flash memory containing the valid information is erased. Otherwise, this valid information will be erased along with the invalid or unavailable information in the flash memory.

Older flash memories had to be erased all at one time (i.e., a portion of older flash memories could not be erased separately from other portions). Thus, with these older flash memories, a spare memory, equal in size to the flash memory, had to be available to store any valid files to be preserved while the flash memory was being erased. This spare memory could be a RAM chip, such as a static RAM or DRAM, or could comprise another flash memory. These valid files were then returned from the spare memory to the flash memory after the flash memory was erased. Accordingly, any space on the flash memory which had been taken up by the unwanted and deleted files is again made available for use.

In later flash memories, a portion of the flash memory could be erased separately from other portions of the flash memory. Accordingly, a particular target unit of the flash memory (i.e., the erase unit—the unit to be erased) is selected based on such criteria as dirtiness and wear leveling. Then, available free space in other blocks of the flash memory is located, and any valid data from the target unit is moved to the available space. When all valid data has been moved to the available free space, the target unit is erased (reclaimed) separately from the other units of the flash memory. This reclamation can be implemented at various times such as when there is insufficient free space to satisfy an allocation request, when the ratio of de-allocated space to block size exceeds a threshold value, when there is a need to defragment the memory, or otherwise.

Journaling is the process of maintaining a log that supports the storage of information in memory such as flash memory. In essence, the journal or log catalogues the files that are stored on the flash memory. A journaling file system is a file system that logs changes to a journal before actually writing them to the main file system.

File systems tend to be very large data structures so that updating them to reflect changes to files and directories usually requires many separate write operations. Because of the large number of write operations that can occur, a race condition can result in which an interruption (such as a power failure or system crash) can leave data structures in an invalid intermediate state.

For example, in some file systems, deleting a file involves two steps: 1) removing its directory entry, and 2) marking the file's inode as free space in the free space map. If step 1 occurs just before a crash, there will be an orphaned inode and hence a storage leak. On the other hand, if step 2 is performed first before the crash, the not-yet-deleted inode will be marked free and possibly be overwritten by something else.

One way to recover is for the file system to keep a journal of the changes it intends to make, ahead of time. Recovery then simply involves re-reading the journal and replaying the changes logged in it until the file system is consistent again. In this sense, the changes are said to be atomic (or indivisible) in that they will either have succeeded originally, or be replayed completely during recovery, or not be replayed at all.

Some file systems allow the journal to grow, shrink, and be re-allocated just as would a regular file. Most, however, put the journal in a contiguous area or a special hidden file that is guaranteed not to change in size while the file system is mounted.

A physical journal is one which simply logs verbatim copies of blocks that will be written later. A logical journal is one which logs metadata changes in a special, more compact format, which can improve performance by drastically reducing the amount of data that needs to be read from and written to the journal in large, metadata-heavy operations (for example, deleting a large directory tree).

Journaling can have a severe impact on performance because it requires that all meta-data be written twice. Metadata-only journaling is a compromise between reliability (with respect to the capability of undoing the whole write( ) operation that involved multiple block updates of the file data only) and performance that stores only changes to file metadata (which is usually relatively small and hence less of a drain on performance) in the journal. This journaling still ensures that the file system can recover quickly when next mounted. However, in a case where the meta-data pertaining to a database file has been written but only part of the database file has been written at the time of an interruption, the record being written is invalid, which may mean that the file can contain an invalid record. So, applications maintain a CRC of the record and will check the record before the record is used for any computations, etc. and will discard the record if it is invalid.

Also, appending to a file in some file systems typically involves three steps: 1) increasing the size of the file in its inode; 2) allocating space for the extension in the free space map; and, 3) actually writing the appended data to the newly-allocated space.

There are some file systems which store the journal information together with the file data being appended. The journal information may consist of a CRC of the file data that is being journalled. In this type of journal, it would not be clear after an interruption whether step 3 was done or not without checking the CRC of the data that matches the CRC of the journal. This checking adds to the associated overhead of performing the CRC each time the data is written.

Thus, the placement of a file system into a stable state following a power interruption requires the scanning of the entire media or the scanning of all virtual tables. This scanning makes data recovery highly inefficient and time consuming, which critically and adversely affects the performance of applications using the media. This problem is compounded by the fact that the size of media keeps increasing as storage technology advances. Thus, scanning of the entire media or the scanning of all virtual tables requires ever increasing amounts of time and exacerbates the inefficiency.

The present invention solves one or more of these or other problems.

### SUMMARY OF THE INVENTION

In accordance with one aspect of the present invention, a method is provided to journal a file operation relating to a file stored in a flash memory. The flash memory contains a file map containing at least one entry about the file. The method comprises the following: locking a semaphore corresponding to the file on which a file operation is to be performed; initializing journaling of the file operation using the file map; performing the file operation on the file; completing journaling of the file operation using the file map; and, unlocking the semaphore.

In accordance with another aspect of the present invention, a method performed at a file system startup with respect to files stored on a flash memory, the method comprises the following: scanning File Maps corresponding to the files/directories; determining whether a file operation is incomplete based on validity flags contained in the File Maps; and, performing remediation so as to eliminate the incomplete file operation.

### BRIEF DESCRIPTION OF THE DRAWINGS

These and other features and advantages will become more apparent from a detailed consideration of the invention when taken in conjunction with the drawings in which:

FIG. 1 is a block diagram illustrating an example of an embedded system in which the present invention can be used;

FIGS. 2, 3, and 4 illustrate a file system architecture useful in explaining a process of journaling in a linear flash file system;

FIGS. 5 and 6 illustrate a file system architecture useful in explaining a process of journaling in an IDE/ATA flash file system; and,

FIG. 7 illustrates a procedure executable by the processor of FIG. 1 in order to generally implement the file operation journaling as described herein.

### DETAILED DESCRIPTION

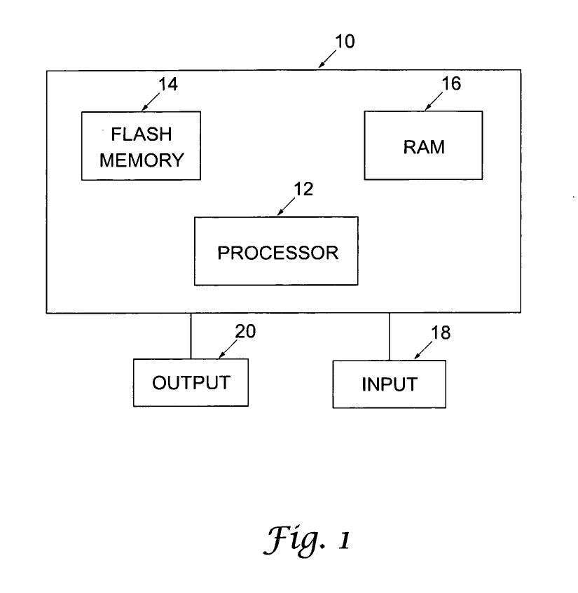

FIG. 1 shows a system 10 which can be an embedded system such as a computer, a personal digital assistant, a telephone, a printer, etc. The system 10 includes a processor 12 that interacts with a flash memory 14 and a RAM 16 to implement the functions provided by the system 10.

Additionally, the system 10 includes an input device 18 and an output device 20. The input device 18 may be a keyboard, a keypad, a mouse or other pointer device, a touch screen, and/or any other device suitable for use by a user to provide input to the system 10. The output device 20 may be a printer, a display, and/or any other device suitable for providing output information to the user of the system 10.

A number of abbreviations and definitions are useful to understand at the outset and can be referred to in the description below.

EU is an abbreviation for Erase Unit.

EB is an abbreviation for Extent Block pair.

MCEU is an abbreviation for Master Control Erase Unit.

TBMCEU is an abbreviation for To Be Next Master Control Erase Unit. FMAP is an abbreviation for File Map.

Block—A flash memory typically contains a plurality of Erase Units. An Erase Unit is divided into smaller blocks referred to as Extents, and an Extent is further divided into Blocks. A Block is the smallest allocation unit of the storage device. The sizes of Extents and Blocks may vary based on partition size (storage media size), and also based on the configuration of the file system, but typically do not vary within a storage device. The file system of a storage device maintains in the Master Control Erase Unit a free, dirty, or bad state for each Block of the storage device. The size of a block may be 512 bytes or a multiple of 512 bytes.

Bad Block—A Block in which no write/read operations can be performed.

Dirty Block—A Block containing non-useful (unwanted) information.

Erase Suspend—An erasure of the data in an Erase Unit can be deferred (suspended) for some time while file operations are being performed. This feature is supported by some flash memories and can be utilized to reduce the file system latency for reads and writes.

Extent—A contiguous set of Blocks. An Extent usually comprises an even multiple of Blocks. Files are typically allocated at the Extent level, even when only one block is required. This Extent allocation is done to prevent fragmentation and to help in reclamation.

Erase Unit—An Erase Unit is the smallest unit of a flash memory that can be erased at a time. A flash memory typically consists of several Erase Units.

Erase Unit Health—The number of times that an Erase Unit has been erased.

Erase Unit Information—For each Erase Unit in the flash memory, certain information, such as Erase Unit Health, and an identification of the Free, Dirty and Bad Blocks of the Erase Unit, needs to be maintained. This information is typically stored both in RAM and also within the Master Control Erase Unit of a flash memory.

File Map Block—The meta data of a file stored on the flash memory 14 is stored in File Map Blocks. This meta data includes information about offset within a file, the useful length within the Block, and an identification of the actual Extent and the actual Blocks within the Extent containing file data. The amount of file data contained in a block is called the useful length of the block. The rest of the block is in an erased state and can receive additional data.

Inode—An inode is a block that stores information about a file such as the file name, the file creation time, and file attributes; also, the Inode points to the File Map block which in turn points to the file data blocks. The file data blocks typically are the smallest storage units of a flash memory.

Incore Inode—For each file that exists on the flash memory 14, there exists an Incore Inode in the RAM 16 that contains information such as file size, file meta data size, Inode Extent and Block number, information on file locks, etc.

Master Block—The Master Block is the first block of the Master Control Erase Unit and contains the file system signature, basic file system properties, and the To-Be-Next Master Control Erase Unit.

Master Control Erase Unit—The logical Erase Unit that contains the crucial file system information for all Erase Units of the flash memory allocated to a file system partition. Thus, there is typically only one Master Control Erase Unit per file system partition on the flash memory 14. A Master Control Erase Unit might be thought of as a header that contains information about the Blocks and Extents of the one or more Erase Units associated with the Master Control Erase Unit.

To-Be-Next Master Control Erase Unit—The logical Erase Unit that will act as the Master Control Erase Unit after an original Master Control Erase Unit is reclaimed.

Reclamation—The method by which useful data blocks are transferred from one Erase Unit (the targeted Erase Unit) as needed to another Erase Unit (a free Erase Unit) so that, mainly, dirty blocks created as result of file overwrite operations and file data deletions can be erased, and so that the flash memory 14 can be wear-leveled. Reclamation is required because, on a flash memory, once a bit is toggled from 1 to 0, that bit cannot be changed back to a 1 again without an erase of the whole Erase Unit containing this bit. Also, because the Erase Unit size is so large, the file system of a flash memory divides and operates on Extents and Blocks.

Wear-Leveling—Because a flash memory consists of Erase Units, the life of a flash memory depends on effective wear leveling of the Erase Units because the flash memory has a definite life span, typically several million erasures, and once an Erase Unit wears out, no file operations can be performed on that Erase Unit, which severely impairs the file system.

Wear-Leveling Threshold—The maximum difference in erase counts between the Erase Unit having the most erasures and the Erase Unit having the least erasures. If an Erase Unit falls outside this band, the data in this Erase Unit is relocated and the Erase Unit is erased.

As mentioned above, the recovery of file data and the placement of the file system into a stable state following an interruption, such as a power interruption or a system crash, has required the scanning of the entire media or the scanning of all virtual tables, and this scanning makes data recovery highly inefficient and time consuming.

One way to increase recovery efficiency and to decrease recovery time is to consider the flash memory in terms of groups of data blocks. Such a group of data blocks, for example, may be an Extent. Extents are typically of uniform size, and information about physical addresses can be quickly derived from the Extent itself without storing such physical addresses in the data log. Thus, using Extents during recovery solves the issue of physical storage. (The extent number is an integer starting with 0 and incrementing through the end of the storage media. The extent number is nothing more that an address determined by adding the extent's offset to the 0 physical address. Thus, in order to determine this physical address, the device offset is added to the following calculation: (extent number * size of extent in bytes)+(block number * size of block in bytes).)

The log information is stored as part of the FMAP (File Map Block), which reduces the overhead of performing multiple write operations. Thus, because the log is part of the File Map, a File Map entry is initially written with its validity flag set to the INITIAL state. The desired operation corresponding to the log entry then is performed on the file, after which the log entry in the corresponding File Map is updated to the VALID state.

Accordingly, there are no separate log blocks because all log information is journaled in the File Maps. This journaling is unique and results in both less overhead in terms of the number of write operations that would have been required if explicit journaling using separate log blocks were used and improved performance because fewer write operations are performed. This journaling using the meta data (e.g., the File Map) instead of journaling the file system explicitly using separate log blocks of memory is referred to as implicit journaling.

This implicit journaling approach is used for both Linear flash file systems and IDE/ATA flash file systems. In the case of both Linear flash file systems and IDE/ATA flash file systems, each file operation involving a change to the data on the storage media, such as open( ), write( ), unlink( ), and rename( ), is journaled using File Map entries. Additionally, in the case of linear flash memories, reclamation operations are journaled using File Map entries.

Also described herein are unique ways of detecting incomplete file operations caused by interruptions and of correcting these incomplete file operations by either completing the file operations or by undoing the file operations based on the progress of each operation during recovery so as to place the file system into a consistent state (normal state) during a subsequent startup of the file system.

Accordingly, the file system journaling and recovery described herein may implement implicit journaling, since the file system does not allocate separate storage space for journaling the transactions. Instead, the meta-data itself contains a journal field, thereby reducing the implementation complexity and also improving the error recovery latency time.

Also, in the file system, both the meta data and the file data are stored in the form of blocks. These blocks are connected in a logical order by links.

Moreover, the journaling and recovery method disclosed herein does not undo a file creation operation, a file deletion operation, or a write operation once the operation is complete, However, it does provide a way of placing the file system in a stable state without losing blocks of stored file data by recovering the blocks when operations are deemed to be incomplete or complete. This placing of the file system in a stable state is the normal usage scenario for the system disclosed herein as there is no manual interaction by the user.

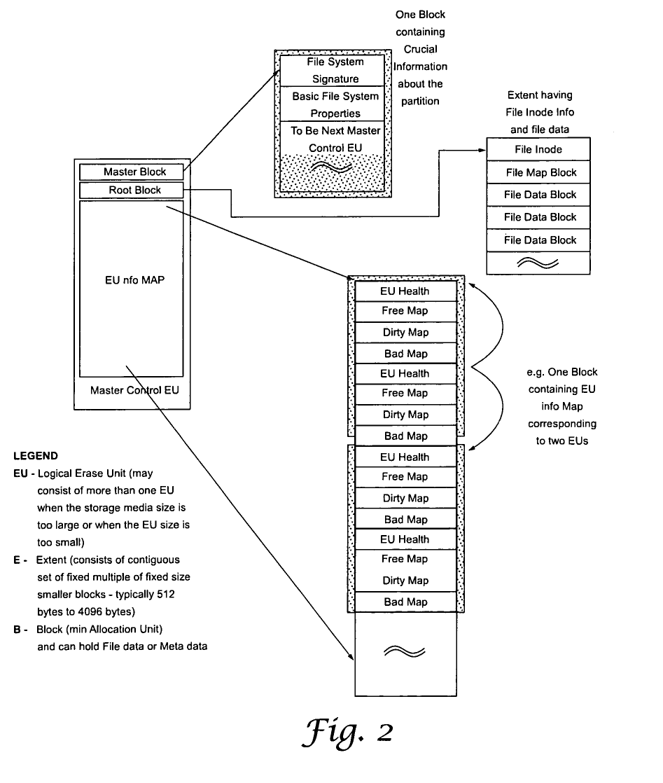

FIG. 2 illustrates an example of a Master Control Erase Unit stored on the flash memory 14. The first block of the Master Control Erase Unit is the Master Block that contains such meta-data as file system signature, basic file system properties, and a To-Be-Next Master Control Erase Unit.

The file system signature is used to identify whether the flash memory 14 is formatted and initialized or not.

The properties contained in the basic file system properties block include, for example, the size of a file system partition, Block size, Extent size, root Inode information, Erase Unit information in terms of Erase Unit Health, free block maps, dirty block maps, bad block maps, etc. Files are allocated at the Extent level.

The To-Be-Next Master Control Erase Unit identifies the new logical Erase Unit that will act as the Master Control Erase Unit after the original Master Control Erase Unit has been reclaimed, i.e., the information stored in the original Master Control Erase Unit has been relocated to the To-Be-Next Master Control Erase Unit and the original Master Control Erase Unit has been erased.

The next Block of the Master Control Erase Unit is the root Block. The root Block contains a pointer to the file Inode associated with a file. The file Inode contains a file map block and file data blocks.

The rest of the Master Control Erase Unit contains map information. The map information consists of all meta-data information pertaining to each Erase Unit such as Erase unit number, the health of the Erase Unit, erase count, the free/dirty/bad state of the Blocks in the Erase Unit, etc.

The root directory, the sub-directories, and the files form a meta-data hierarchical structure. According to this hierarchical structure, the root directory meta-data structures contain pointers to sub-directories and files under the root, the sub-directories meta-data structures in turn contain pointers to their sub-directories and files, and the file meta-data structures contain pointers to the file data Blocks.

The root block contains the root directory entry information, i.e., as shown in FIG. 2, the root block consists of an entry (link) pointing to a File Map block. Each VALID entry of a directory File Map points to either a file or another directory. The directory that appears under any other directory is also referred to as a sub-directory.

Thus, each File Map entry of a file map block of a directory contains entries pointing to the Inode block of a file or another directory. If the file or directory entry is deleted, the entry is marked as dirty by setting all bits to 0. Extended File Map blocks are used when all of the entries in the File Map block are used up with either valid entries or dirty entries.

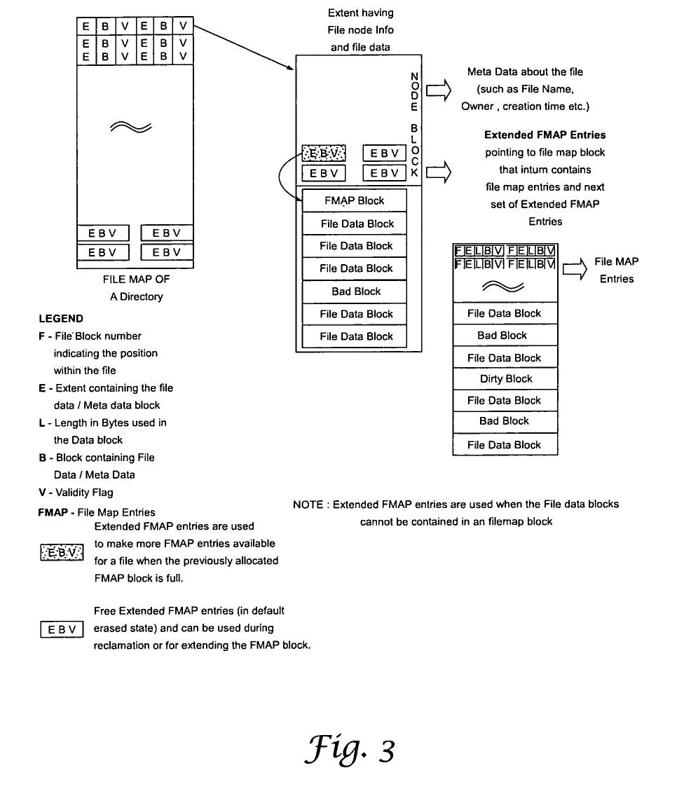

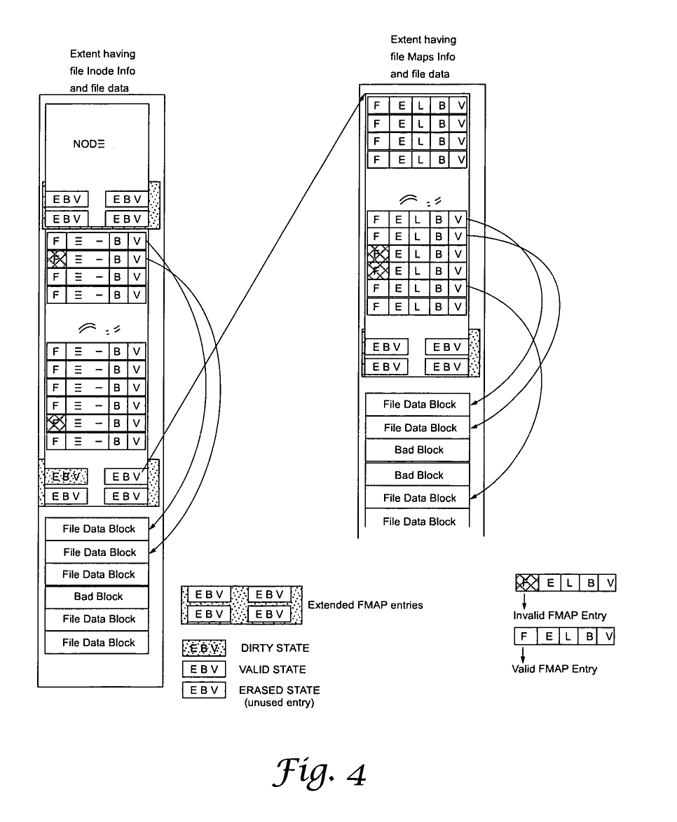

FIG. 3 shows a File Map block of a directory that is pointed to by an Inode. A directory File Map has only EBV entries. The E entry points to an extent containing a corresponding meta-data block, the B entry points to a block within the extent that contains corresponding meta-data, and V is an entry indicating a state of the meta-data in the corresponding block.

As indicated by the middle section of FIG. 3, a File Map of a directory points to a File Map associated with file data. As indicated by the right hand section of FIG. 3, one of four File Maps is pointing to a File Map block associate with file data. This File Map contains FELBV entries. The F entry contains data indicating the file block number of a corresponding block containing file data, the E entry points to an extent containing this file data, the L entry contains information indicating the length in bytes of the block containing file data, the B entry points to the block in the extent containing the file data, and the V entry is a validity flag indicating a state of the corresponding data. One File Map block may not be sufficient to contain all of the file map entries for a large file. Hence, extended File Map blocks are linked by an extended FMAP entry from a parent File Map block to accommodate this large file.

Seven processes for performing journaling on flash media in a linear flash file system are now described. In each of these seven processes, the operations are journaled in the relevant File Map so that recovery is assisted following an interruption during a file operation.

Process 1—When a write transaction in append is journaled, the file/semaphore corresponding to a file partition to which a file is to be appended is locked, a new data block for the write( ) operation is allocated and this block is set as used, a validity flag in an FMAP entry that corresponds to the position of the data within the file to be written is set to a default erased state and the fmap entry is written into the first free fmap entry of the last fmap block used by the file, the actual write of the file data to the new data block is performed, the validity flag in the fmap entry is changed to the valid state, and the file/semaphore is unlocked. (If the File Map block is required to be linked, it is linked from the parent. That is, when the File Map block (FMAP block) is full, a new FMAP block is appended to the existing FMAP block through a link from the extended FMAP entry to point to the new FMAP block. Accordingly, the existing File Map block is the parent and the new File Map block is the child.)

This validity flag is the journal entry in the File Map. The validity flag, for example, may be one byte in length and its value represents the state of the completion of an operation.

Process 2—When a write transaction in the overwrite mode is to be journaled, the file/semaphore corresponding to the partition containing the file which is to be overwritten with the new file data is locked, a new data block for the write( ) operation is allocated and this block is set as used, a validity flag in the new FMAP entry that corresponds to the position of the data within the file to be written is set to the default erased state, the actual writing of the new file data is performed by overlaying the older data at that position and writing the new file data to the newly allocated data block, the validity flag in the new File Map entry is set to the valid state, the validity flag of the old File Map entry is set to the dirty state, and the file/semaphore is unlocked.

Process 3—When the creation of a file in the file system is to be journaled, the file/semaphore corresponding to a partition containing the file to be created is locked, two free data blocks (one for the Inode and another for the File Map block) are allocated for the file creation operation and these blocks are set as used, entries for the new files are added to the parent File Map and the validity flag in the parent File Map is set to the default erased state, inode information is written into the new Inode block and into the new File Map block and their validity flags are set to the valid state, an Incore Inode is allocated for the new file being created, the validity flag in the parent File Map is updated to the valid state, and the file/semaphore is unlocked.

Process 4—When a file deletion in the file system is to be journaled, the corresponding file/semaphore is locked, the validity flag in the Incore Inode is set to the deletion state so as to prevent a reclamation thread from reclaiming that file, the entry in the parent File Map corresponding to the file to be deleted is updated by setting its validity flag to the deleted state, the file is traversed and all valid file data blocks, all valid File Map blocks, and the Inode block are set to the dirty state by setting the validity flags in the file maps corresponding to these file data blocks, file map blocks, and the inode block to the dirty state, the file entry in the parent File Map corresponding to the file to be deleted is updated by changing its validity flag from the deleted state to the dirty state (all zeros), the Incore Inode is freed up, and the file/semaphore is unlocked.

Process 5—When a file/directory rename operation is to be journaled, the file/semaphore corresponding to a partition containing the file to be renamed is locked, a new block is allocated for the Inode, a new entry in the parent's File Map is added for the new entry with the validity flag in this new entry set to the erased state, the updated inode information is written, the validity flag in the entry for the old Inode in the parent File Map is set as a dirty entry, the validity flag in the entry for the new Inode in the parent File Map is set as a valid entry, the Incore Inode for the new file hash is updated, and the file/semaphore is unlocked. (If source and destination paths are different, an actual copy of the file/directory occurs. The source path is the existing file name, and the destination path is the new file name that replaces the existing file name.)

Process 6—In case of a rename operation in the same partition, the destination file name is obtained, and a hash of the name is computed. A new block is allocated and is set as used. A new file entry is added in the parent directory, with the validity flag set to the INITIAL_STATE. The inode with the updated name is written in the newly allocated block. The validity flag in the parent directory filemap entry is changed to the VALID_STATE and the old filemap entry corresponding to the previous file name in the parent directory is set to the INVALID_STATE. The hash of the file is used by the file system internally for several purposes, such as searching in the incore inodes list for the hash value of a file to be retrieved so that further operations can be performed on it.

Process 7—When a reclamation in the file system is to be journaled, the file/semaphore corresponding to a partition in the targeted erase unit to be reclaimed is locked, all valid blocks are relocated from the erase unit targeted for reclamation to another new erase unit, and the file lock or semaphore is unlocked to allow file updates for the file being relocated to the new erase unit. This process proceeds on a one-block-at-a-time basis such that the semaphore is locked, a block is moved, the semaphore is unlocked, the semaphore is locked, another block is moved, and so on. This one-at-a-time process prevents hogging of the CPU and allows file operations to continue.

This process may involve re-locating more than one file in the targeted erase unit because an erase unit may store more than one file.

Once all the blocks from the targeted erase unit have been re-located to the new erase unit, the targeted erase unit that is being reclaimed is erased. The semaphore corresponding to the new erase unit is locked, the new erase unit information for the erase unit being reclaimed is appended, the old erase unit information is marked as dirty, and the semaphore is unlocked.

As the blocks are moved from the targeted erase unit to the new erase unit, the move to the new erase unit is journalled in the same manner as that described above in Process 1 relating to write operations.

Process 8—During a file system startup, a number of operations are performed during recovery in order to bring the file system to a consistent state. A consistent state simply means a stable state with no incomplete operations. The journaling approach described herein, on detecting an incomplete operation, fixes this error by completing the operation based on the validity flags and also based on the allocation logic or by undoing the last operation and recovers any blocks that might lead to storage block leaks. An operation is considered as incomplete if the validity of the flag is not valid. The blocks related to an incomplete file operation are recovered by marking them as dirty because the data that they contain might not have been written completely.

Accordingly, in a first operation, the links are validated (i.e., the validity flags in the relevant fmap entries are in the valid state) and the meta-data blocks that have not been completely written are marked as dirty blocks (the normal reclamation process will eventually reclaim these dirty blocks).

In a second operation, in case there are duplicate file map entries, the older duplicate file map entries are invalidated.

In a third operation, if an erase unit has been partially erased before a power failure, the erase operation for that Erase Unit is completed. An erase operation interruption is easily detected by the fact that all the blocks in that Erase Unit are dirty. In this case, all of the blocks in the Erase Unit are in dirty state. The Erase Unit information table for all Erase Units is also populated in the RAM structures as part of file system initialization. The reclamation thread always determines which Erase Unit has to be reclaimed based on the Erase Unit Information table populated/created in the RAM. So, this determination is the first job performed by the reclamation thread after the reclamation thread is spawned/created.

In a fourth operation, if an Erase Unit was under reclamation when a power interruption occurred, the reclamation for the Erase Unit is continued and completed after the startup. Again, an Erase Unit reclamation interruption is easily detected by the fact that conditions for the reclamation of that Erase Unit is still valid because the algorithm is the same.

In a fifth operation, if an incomplete file deletion operation is detected during a scan of the parent's File Map block, the deletion operation is completed by marking all blocks used by that file as dirty (including all fmap entries, fmap blocks and data blocks) and by updating the entry for that file in the parent File Map to change its validity flag from the deleted state to the dirty state.

During deletion, the file/directory is marked for deletion by setting the state of the validity flag in the corresponding File Map to DELETE_STATE indicating that the file system is in the process of deleting the file/directory. An incomplete file deletion is detected if the validity flag is in the DELETE_STATE during start up following an interruption.

In a sixth operation, if an incomplete file creation is detected, the blocks set aside for the newly created file are marked as dirty (which includes all blocks in the corresponding Extent), and the entry in the parent File Map corresponding to this file is updated to change its validity flag from the default erased state to the dirty state.

During a file creation, the File Map entry is written with the block used for storing Inode, and the validity flag is left in the default erased state in the parent's directory filemap entry (after identifying a free filemap entry in the parent's last file map block). An incomplete file creation is detected if the validity flag is in the default erased state (also known as the initial state) during start up following an interruption.

An incomplete write operation is detected when the validity flag in the fmap entry is not in the valid state.

An incomplete rename operation is detected as follows. If the validity flag is in the initial state, the inode information is checked to determine if the inode was written completely. If the fmap entry is in erased state, then the rename operation is incomplete and the Inode block is set as dirty and its fmap entry is marked as invalid. If the validity flag is in the initial state, and if the inode was written completely written and the file has at least one data block, it is apparent that the file is being renamed. In this case, a search is made for the file whose first fmap block corresponds to the fmap block of the new renamed inode block. After identifying this file, the new fmap entry is validated and old fmap entry is removed from the parent FMAP.

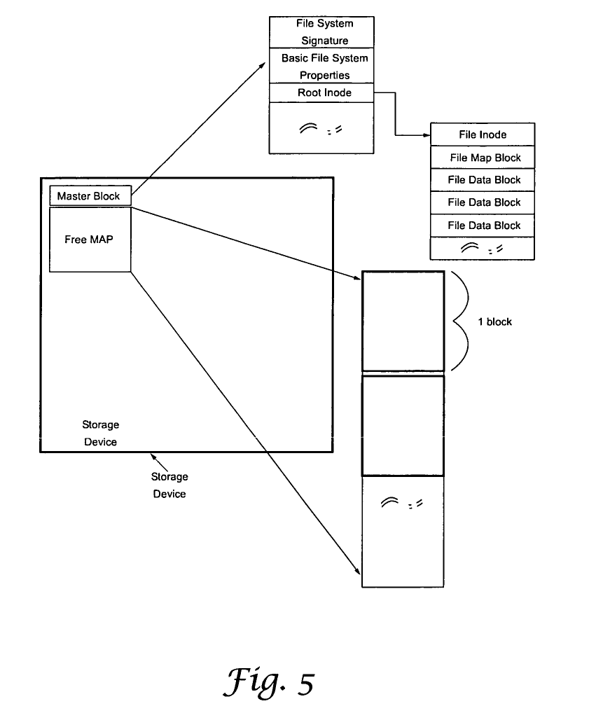

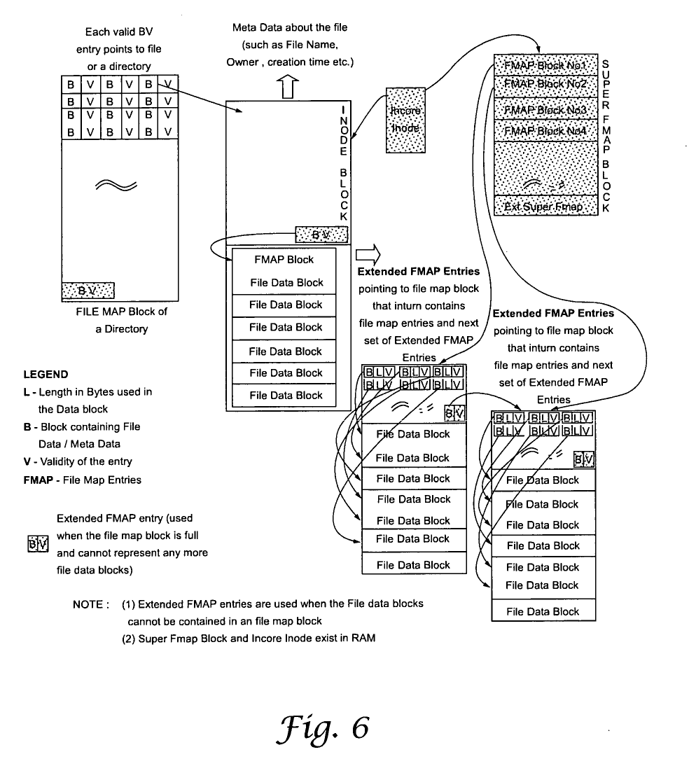

FIGS. 5 and 6 illustrate implicit journaling in connection with flash media in an Integrated Drive Electronics/Advanced Technology Attachment (IDE/ATA) Flash File System. As shown in FIG. 5, an IDE/ATA flash media stores a Master Block. As indicated by the upper section of FIG. 5, the Master Block contains such meta-data as file system signature, basic file system properties, and the root Inode.

As before, the file system signature is used to identify whether the flash memory 14 is formatted and initialized or not.

The properties contained in the basic file system properties block include, for example, the size of a file system partition, Block size, Extent size, root Inode information, Erase Unit information in terms of Erase Unit Health, free block maps, dirty block maps, bad block maps, etc. Files are allocated at the Extent level.

As indicated by the right hand section of FIG. 5, the root Inode contains an FMAP and file data blocks.

The free map section contains free map blocks that are used to store the allocation bitmap information of the blocks within the storage media. A bit having a value of 1 indicates that the corresponding block is free, whereas a bit having a value of 0 indicates that the corresponding block is used.

Based on the storage media size, the size of the free map could span one block to multiple blocks and is based on the following factor: free map size in bytes=storage media size in blocks/(Block Size In Bytes * 8); free map size in blocks=free map size in bytes/(block size in bytes).

The left hand section of FIG. 6 shows that a File Map block of a directory contains B and V entries. The B entry is a pointer to an Inode block that contains meta-data such as filename, file hash, creation date, and extended fmap entry pointing to an FMAP block and pointers to blocks of file data, and the V entry is a validity flag that is used to indicate the state of this meta-data.

Each FMAP contains BLV entries. The B entry is a pointer to a block containing corresponding file data, the L entry indicates the length in bytes of the file data stored in the corresponding file block, and the V entry is a validity flag that is used to indicate the state of this file data.

An Incore Inode is stored in RAM and is used to connect the Inode Block to a Super FMAP Block that is also stored in RAM. The Super FMAP Block contains links to extended FMAP blocks each of which contains BLV entries. The B entry is a pointer to a block containing corresponding file data, the L entry indicates the length in bytes of the file data stored in the corresponding file block, and the V entry is a validity flag that is used to indicate the state of this file data.

The purpose of the Super Fmap Block is to cache the fmap blocks in the logical sequence of the file data contents in the RAM when a file is opened for a read/write operation. This approach provides a deterministic behavior to make known which filemap block and which filemap entry must be read in order to perform the read or write operation, based on the position of the file pointer with in the file.

Five processes for performing journaling on flash media in an Integrated Drive Electronics/Advanced Technology Attachment (IDE/ATA) Flash File System are now described with reference to the flash file system architecture shown in FIGS. 5 and 6.

Process 1—When a write transaction in append is journaled, the file/semaphore corresponding to a partition containing a file to be appended is locked, a new data block for the write( ) operation is allocated, a validity flag is appended to the FMAP entry that corresponds to the position of the data within the file to be written (the validity flag in this journal entry is initially in the default erased state), this allocated block is set as used, the actual write of the file data to the non-volatile media is performed, the validity flag is changed to the valid state, and the file/semaphore is unlocked.

No journaling of write transactions is performed in the overwrite mode because the blocks are already allocated and only the file data needs to be updated.

Process 2—When the creation of a file in the file system is to be journaled, the file/semaphore corresponding to a partition for the file to be created is locked, two free data blocks (one for the Inode and another for the File Map block) are allocated for the new file creation operation, an entry for the new file is added to the parent File Map and the validity flag in this entry is set to default erased state, inode information is written into the Inode block with the extended filemap entry pointing to the File Map block and its validity flags is set to the valid state, an Incore Inode is allocated for the new file being created, the File Map block for the new file is set as used, the Inode block for the new file is set as used, the validity flag corresponding to file entry in the parent File Map entry is updated to the valid state, and the file/semaphore is unlocked.

Process 3—When a file deletion in the file system is to be journaled, the file/semaphore corresponding to the partition containing the file be deleted is locked, the entry in the parent File Map corresponding to the file to be deleted is updated by setting its validity flag to the deleted state, all valid file data blocks, all valid File Map blocks, and the Inode block corresponding to the file to be deleted are traversed and the corresponding fmap entries are set as dirty/invalid state and all blocks used are set as free,, the file entry in the parent File Map corresponding to the file to be deleted is updated by changing its validity flag from the deleted state to the dirty state (all zeros), the Incore Inode is freed up, and the file/semaphore is unlocked.

Process 4—When a file/directory rename operation is to be journaled, the file/semaphore corresponding to a partition containing the file to be renamed is locked, the file's Inode is updated by changing the file's name to the new name, the Incore Inode for the new file hash is updated, and the file/semaphore is unlocked. (If source and destination paths are different, an actual copy of the file/directory occurs.)

Process 4 does not rely on validity flags because, in ATA flash devices, the flash device itself handles the journaling and, hence, the overwrite is performed at the same block with the updated inode information.

Process 5—During a file system startup, a number of operations are performed during recovery in order to bring the file system to a consistent state.

In a first operation, if an incomplete file creation is detected in the manner described above, the blocks set aside for the newly created file are marked as free, and the entry in the parent File Map corresponding to this file is updated set all fields of the fmap entry corresponding to the file being created to the erase state.

In a second operation, if an incomplete file deletion operation is detected during a scan of the parent's File Map block in the manner described above, the deletion operation is completed by marking all blocks (meta-data blocks, data blocks, and Inode block) as free for that file, and the entry in the parent File Map for that file is updated by changing its validity flag from the deleted state to the dirty state.

In a third operation, links are validated and file meta-data blocks that have not been completely written are processed to either complete the operation or to undo the change being performed and the logic to prevent leaks on the storage media. Thus, the last internal operation is undone and the blocks which would have led to leaks in the storage media are recovered. Accordingly, the file system is placed into a consistent state.

Therefore, during a system start up following an interruption, all File Map entries pertaining to all files and directories (including all sub-directories because a sub-directory is nothing more than a directory under a parent directory) are scanned (traversed). During this traversal, an incomplete file operation is detected from the state of the validity flags and is accordingly corrected. At any given time, there can be only one incomplete file operation in a file system partition because of the architecture and design implementation of a flash memory (only one file operation is allowed to be completed before the next is performed).

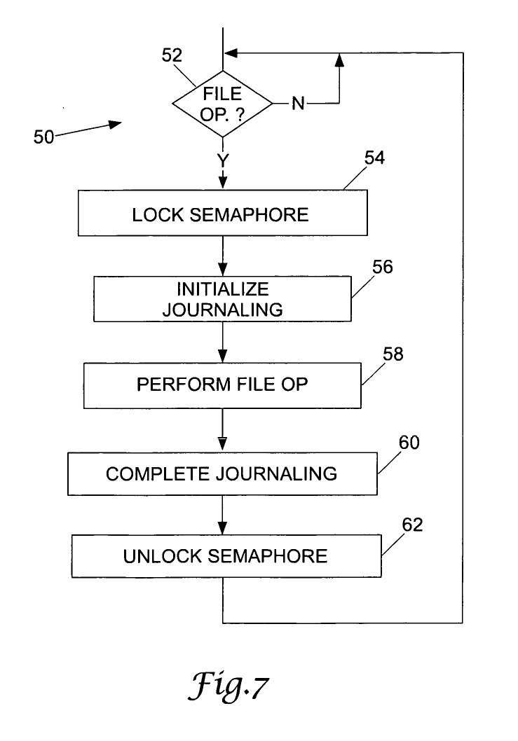

FIG. 7 illustrates a procedure 50 executable by the processor 12 of FIG. 1 in order to generally implement the file operation journaling as described above. Accordingly, the procedure 50 at 52 determines that that a file operation has been initiated, the file/semaphore pertinent to that file operation is locked at 54.

Then, at 56, journaling is initialized. This journaling initialization typically involves setting one or more validity flags in FMAP entries pertinent to the file operation to one or more pertinent states depending on the particular file operation being performed. For example, in the case of a write transaction in append file operation, a validity flag in a pertinent FMAP entry is set to the default erased state.

Following or during journaling initialization, the actual file operation is performed at 58. For example, during a write transaction in append file operation, the actual write of the file data to the new data block is performed. However, as will be understood from the processes described above, the file operation may be a complex matter having several procedural elements.

Following or during performance of the file operation, journaling is completed at 60. Completion of journaling typically involves setting one or more validity flags in FMAP entries pertinent to the file operation to one or more pertinent states depending on the particular file operation being performed. For example, during a write transaction in append file operation, the validity flag in the fmap entry is changed to the valid state.

Finally, at 62, the pertinent file/semaphore is unlocked.

The prior art takes a long time for a file system startup and requires an abundance of RAM because the links for the file system are stored in RAM. In larger media (such as 1 GB), the startup time may typically consume from a few seconds to a few minutes. Such a large startup time is not acceptable in many applications, which require almost instantaneous startup. The prior art is also not easily adaptable because of its complexity.

In journaling linear flash file systems, the prior art does not teach a method to maintain an erase count of erase units across power fail situations, which is required for proper wear leveling of the media. Since the Erase Unit Info is maintained in the Super Erase Unit itself, when the Erase Unit is reclaimed, the old Erase Unit Info in the Super Erase Unit is marked as dirty and the new Erase Unit Info is appended to the Erase Unit Info data. In the prior art, the Erase Unit info is maintained within the Erase Unit itself. Hence, if an interruption occurs just after the Erase Unit is erased, the erase count is lost.

In journaling IDE/ATA file systems, the prior art method is inefficient because the logic is centered on real hard disk behavior and does not efficiently use the features of electronic storage IDE devices.

Certain modifications have been discussed above. Other modifications will occur to those practicing in related arts. For example, journaling and recovery have been specifically described above in terms of flash memory. However, the journaling and recovery described above can be used in conjunction with other persistent memory devices.

Accordingly, the detailed description is to be construed as illustrative only and is for the purpose of teaching those skilled in the art the best mode of carrying out the method and/or apparatus described. The details may be varied substantially without departing from the spirit of the invention claimed below, and the exclusive use of all modifications which are within the scope of the appended claims is reserved.

What is claimed is:

1. A method of journaling a file operation relating to a file stored in a flash memory, the flash memory containing a file map containing at least one entry about the file, the method comprising:
locking a semaphore corresponding to the file on which a file operation is to be performed;
initializing journaling of the file operation using the file map;
performing the file operation on the file;
completing journaling of the file operation using the file map; and, unlocking the semaphore.

2. The method of claim 1 wherein the performing of the file operation comprises performing a write transaction in append, wherein the initializing of the journaling of the file operation using the file map comprises setting a validity flag of the file map to an initial erased state, and wherein the completing of the journaling of the file operation using the file map comprises changing the validity flag to a valid state following writing of the file.

3. The method of claim 1 wherein the performing of the file operation comprises performing a write transaction in an overwrite mode, wherein the initializing of the journaling of the file operation using the file map comprises setting a first validity flag for a new data block to a default erased state, and wherein the completing of the journaling of the file operation using the file map comprises:
setting the first validity flag to a valid state following writing of file data to the new data block; and,
setting a second validity flag for an old data block containing data to be overwritten to a dirty state following writing of the file data to the new data block.

4. The method of claim 1 wherein the performing of the file operation comprises performing a file creation, wherein the initializing of the journaling of the file operation using the file map comprises setting a validity flag of a file map block to an erased state, and wherein the completing of the journaling of the file operation using the file map comprises:
changing the validity flags to a valid state following writing of information into an Inode block; and,
updating an extended filemap entry to point to a filemap block allocated for the file creation.

5. The method of claim 1 wherein the performing of the file operation comprises performing a file deletion, wherein the initializing of the journaling of the file operation using the file map comprises setting a validity flag in a file map corresponding to the file, and wherein the completing of the journaling of the file operation using the file map comprises changing the validity flag from the deleted state to a dirty state following deletion of the file and upon recovering of all the blocks used by the file.

6. The method of claim 1 wherein the performing of the file operation comprises performing a file rename, wherein the initializing of the journaling of the file operation using the file map comprises setting a first validity flag of a file map corresponding to a new meta-data block allocated for a new name of the file to an erased state, x and wherein the completing of the journaling of the file operation using the file map comprises:
setting a second validity flag of a file map corresponding to an old meta-data block containing an old name for the file to a dirty state; and,
changing the first validity flag to a valid state following writing of inode information with the updated name in a newly allocated inode block.

7. The method of claim 1 wherein the performing of the file operation comprises performing a reclamation, wherein the initializing of the journaling of the file operation using the file map comprises setting a validity flag of the file map corresponding to a new block to which valid data from a reclaimed block is to be relocated to an initial erased state, wherein the performing the file operation on the file comprises relocating the valid data to the new block, wherein the completing of the journaling of the file operation using the file map comprises changing the validity flag to a valid state following relocating of the valid data, and wherein the method further comprises:
relocating at least one file data block;
relocating at least one inode block; and,
relocating at least one fmap block.

8. The method of claim 1 wherein the performing of the file operation comprises performing a write transaction in append, and wherein the journaling of the file operation using the file map comprises:
locking a semaphore corresponding to a file partition containing the file to be appended;
allocating a new data block for the write in append operation;
setting the new block as used;
setting a validity flag of the file map corresponding to the new block to an erased state;
writing file data to the new block;
changing the validity flag to a valid state; and,
unlocking the semaphore.

9. The method of claim 1 wherein the performing of the file operation comprises performing a write transaction in an overwrite mode, and wherein the journaling of the file operation using the file map comprises:
locking a semaphore corresponding to a file partition containing the file that is to be overwritten;
overwriting the file data blocks with the updated data; and,
unlocking the semaphore.

10. The method of claim 1 wherein the performing of the file operation comprises performing a file creation, and wherein the journaling of the file operation using the file map comprises:
locking a semaphore corresponding to a partition containing the file to be created;
allocating a first free data block for an inode and a second free data block for a file map block for the file to be created;
setting the first and second free data blocks as used;
adding entries for a new file to a parent file map;
setting a validity flag in the parent file map to a default erased state;
erasing the second free data block used for storing the fmap entries of the file;
writing inode information into the first free data block;
setting validity flags in the first and second free data blocks to a valid state;
allocating an incore inode for the new file being created;
setting the validity flag in the parent file map to the valid state; and,
unlocking the file/semaphore.

11. The method of claim 1 wherein the performing of the file operation comprises performing a file deletion, and wherein the journaling of the file operation using the file map comprises:
locking a semaphore corresponding to a partition containing the file to be deleted;
setting a validity flag in a file map of an incore inode corresponding to the file to be deleted to a deleted state;
setting a validity flag in a parent file map corresponding to the file to be deleted to the deleted state;
traversing the file and setting all valid file data blocks, all valid file map blocks, and the inode block to a dirty state;
setting the validity flag in the parent file map to the dirty state;
freeing up the incore inode; and,
unlocking the semaphore.

12. The method of claim 1 wherein the performing of the file operation comprises performing a file rename, and wherein the journaling of the file operation using the file map comprises:
locking a semaphore corresponding to a partition containing the file to be renamed;
allocating a new block to an inode corresponding to the file;
adding a new entry in the parent's file map for the new name;
setting a validity flag in the new entry to an erased state;
updating inode information in the new block;
setting the validity flag in the new entry to a valid state;
setting a validity flag in an entry for the old inode in the parent's file map to a dirty entry;
updating an incore inode with a new hash for the renamed file; and,
unlocking the semaphore.

13. The method of claim 1 wherein the performing of the file operation comprises performing a file creation, and wherein the locking of a semaphore, initializing of journaling, performing of the file operation, completing the journaling, and unlocking the semaphore comprises:
locking a semaphore corresponding to a partition containing the file to be created;
allocating a first free data block for an inode and a second free data block for a file map block for the file to be created;
adding entries for a new file to a parent file map;
setting a validity flag in the parent file map to a default erased state;
writing inode information into the first free block with an extended fmap entry in the inode block pointing to the second free block;
setting validity flags in the first and second free data blocks to a valid state;
setting the second free data block as used;
setting the first free data block as used;
setting the validity flag in the parent file map to the valid state; and,
unlocking the file/semaphore.

14. The method of claim 1 wherein the performing of the file operation comprises performing a file deletion, and wherein the locking of a semaphore, initializing of journaling, performing of the file operation, completing the journaling, and unlocking the semaphore comprises:
locking a semaphore corresponding to a partition containing the file to be deleted;
setting a validity flag in a parent file map corresponding to the file to be deleted to the deleted state;
setting all valid file data blocks, all valid file map blocks, and the inode block to a free state;
setting the validity flag in the parent file map to the dirty state;
freeing up an incore inode corresponding to the deleted file; and, unlocking the semaphore.

15. A method performed at a file system startup with respect to files stored on a flash memory, the method comprising:
scanning file maps corresponding to the files/directories;
determining whether a file operation is incomplete based on validity flags contained in the file maps; and,
performing remediation so as to eliminate the incomplete file operation.

16. The method of claim 15 wherein the performing of remediation so as to eliminate the incomplete file operation comprises completing the file operation.

17. The method of claim 15 wherein the performing of remediation so as to eliminate the incomplete file operation comprises:
undoing the incomplete operation; and,
recovering any blocks that might lead to storage block leaks.

18. The method of claim 15 further comprising:
validating links; and,
marking as dirty any meta-data blocks that have not been completely written.

19. The method of claim 15 further comprising invalidating older duplicate file map entries in the event that there are duplicate file map entries.

20. The method of claim 15 further comprising:
detecting an erase operation interruption based on all blocks in an erase unit being marked with a dirty state; and,
completing the erase operation for the erase unit.

21. The method of claim 15 further comprising:
detecting an incomplete reclamation of an erase unit based on a valid state of at least one block in the erase unit; and,
completing the reclamation for the erase unit.

22. The method of claim 15 further comprising:
detecting an incomplete file deletion if a validity flag corresponding the file being deleted is in a delete state;
completing the file deletion.

23. The method of claim 22 wherein the completing of the file deletion comprises:
marking any meta-data blocks, data blocks, and inode blocks corresponding to the file being deleted as free; and,
setting a validity flag of a file map corresponding the file being deleted to a dirty state.

24. The method of claim 15 further comprising:
detecting an incomplete file creation if a validity flag corresponding to the file being created is in a default erased state; and,
undoing the file creation by marking any blocks set aside for the file being created as dirty and by setting a validity flag in a file map corresponding to the file being created to a dirty state.

25. A method of journaling a file operation relating to a file stored in a flash memory, the flash memory containing a file map containing at least one entry about the file, the method comprising:
locking a semaphore corresponding to the file on which a file operation is to be performed;
performing the file operation on the file;
journaling the file operation using the file map; and,
unlocking the semaphore.
